(19) United States
(12) Patent Application Publication
(10) Pub. No.: US 2017/0010853 A1
(43) Pub. Date: Jan. 12, 2017

(54) SYSTEM FOR REMOTE CONTROL AND USE OF A RADIO RECEIVER

(71) Applicant: Jeffrey Gelles, Philadelphia, PA (US)

(72) Inventor: Jeffrey Gelles, Philadelphia, PA (US)

(21) Appl. No.: 14/797,178

(22) Filed: Jul. 12, 2015

(51) Int. Cl. G06F 3/16; G05B 15/02

(52) U.S. Cl. CPC G06F 3/165; G05B 15/02

(57) ABSTRACT

A receiver-server device that is a multi-tuner radio equipped with antenna capacity suitable for acquiring signal from multiple stations and providing remote access to that signal on a live or near-live basis via circular memory buffers accessible via the Internet is provided. Further, a smart user device is connected with the receiver-server device through the Internet as an input/output controller to select, scan and hear the available stations in live, near-live and fully time-shifted modes as well as in place-shift mode. A user may rewind or fast-forward the audio stream in a variety of increments or to pause the audio stream or return the audio stream to live monitoring. A home radio is provided for a user that can be accessed from anywhere, irrespective of the user's location, and performs in live, near-live and time-shifted modes.

### FIELD OF THE INVENTION

The present invention generally relates to the field of radio communication and more particularly to an Internet-connected multi-tuner radio with memory, remotely or locally accessible in a normal mode or on a delayed basis.

### BACKGROUND

Radio broadcasting is a well-known technology for providing one-way wireless transmission of media content in the form of radio waves. These media content may be news, weather, interviews, entertainment, traffic reports and the like. The media content are transmitted through radio equipment such as AM or FM broadcasts, satellite radio or HD radio, Internet radio and the like, that can be listened to from a tuned station. Radio is one of our oldest electronic media; however it has lagged in offering some elements of usability now commonplace with television and other audiovisual media, including the ability to pause and rewind a stream of live media. This is partly due to the fact that radio is often listened to from vehicles or from other mobile installations, and that a mobile receiver presents particular impediments to the steady, uninterrupted reception of high-quality radio signal.

Further, a vehicular radio might be powered down for most of any 24-hour period; it might be within a vehicle parked in a signal-blocking garage; it might be within a vehicle that travels beyond the range of a desired station. Numerous types of radio equipment and methodologies for accessing received radio signals have been described in prior art.

There exists a need for a system of radio equipment that can alter and improve a user's experience with traditional radio broadcasts, HD or satellite-radio broadcasts, or Internet-radio transmissions. There exists a need for a system of radio equipment through which users are able to return to information that they have just missed in live mode. Also, there exists a need to provide a home server or a personal Internet server for the user to efficiently utilize the radio equipment.

### SUMMARY

The present invention solves problems unaddressed in prior art by utilizing a multi-tuner, multiband, memory-equipped radio receiver-server device with Internet connection, allowing both input and output to be controlled remotely by any Internet-connected device, including a smartphone, a tablet or a computer.

Aspects of the present invention provide a system comprising a multi-tuner radio receiver-server device and a user's device via which a user can listen to an audio signal from anywhere in live or near-live mode. The system is hardware- and software-based system. The radio receiver-server is equipped with antenna capacity suitable for acquiring RF signal from multiple stations via multiple bands and formats, including AM, FM, HD, DAB, satellite, and Internet capacity and software to collect an audio stream from a preselected Internet-radio source. The system mainly comprises two components: a web-connected, radio receiver-server and a Web- or mobile-device application program. Since, the radio receiver-server is web connected, it acts as a personal server for a user. The radio receiver-server device is equipped with multiple tuners, antenna, and digital memory that provide the user access to either live or near-live broadcast or previously broadcast data on any of a number of preset stations selected on the receiver-server. Further, the application program provides input and output controls for the receiver-server device via a computer, smartphone, or similar mobile device.

In a further aspect of the present invention, the radio receiver-server device is based at the user's location, which may be a home, a workplace or the like. In another aspect, the radio receiver-server device provides digital memory in the form of circular buffers.

In yet another aspect of the present invention, the radio receiver-server device works in a tuner mode. In the tuner mode, an audio output from a tuned station is hearable only in live mode. The web application program on the smart device controls station selection via a tuning bar, scanning of available stations, and direct digital input of station frequencies on a soft keypad or a keyboard of the smart device.

In aspects of the present invention, the radio receiver-server device works in a play mode. Play mode provides a way for selecting one of the preset channels, where the user can listen in live or near-live mode, and can rewind or fast-forward the audio stream in a variety of increments. Also, the user can pause the stream or return the stream to live mode.

Further aspects of the present invention include a web application program with a twin digital time display that shows “time” and “playback time” and controls that allow live and rewound audio to be heard on any of a number of preset stations.

In still further aspects of the present invention, the radio receiver-server device is provided in the form of a custom single board computer (SBC) equipped with tuner chipsets and a solid-state drive (SSD) for memory. The single board computer is used to host both the web application program and the radio receiver. Also, an input means such as a touchscreen, and a control panel and a speaker can be attached to the SBC to allow local control and playback, enabling the receiver-server to be used locally in all its capacities without the need for a handset or other external device.

Aspects of the present invention allow a user to listen to radio information such as news, weather or traffic reports that he or she has just missed; return to the beginning of an interview that began before the radio was turned on or before the user was fully engaged, or re-listen to something surprising or confusing in real time, and to pause, rewind, skip forward, or record via a smart device such as a smartphone, a tablet, or a computer for later listening.

### BRIEF DESCRIPTION OF THE DRAWINGS

FIG. 1A illustrates a system for providing a multi-tuner radio receiver-server device and a user's device to locally or remotely access a preselected set of radio broadcast signals or Internet-streamed signals from anywhere, in accordance with an embodiment of the present invention.

FIG. 1B and FIG. 1C illustrate a user interface of a user device to control a receiver-server device for accessing radio broadcast or streamed signals, in accordance with an embodiment of the present invention.

FIG. 2 illustrates a system comprising a receiver-server device and a user device communicating with each other, for enabling a user access to radio signals, in accordance with an embodiment of the present invention.

FIG. 3A depicts a software architecture of the system disclosed in the present invention, showing a client/user side 304 with a web application program installed on it and a server side 306, in accordance with an embodiment of the present invention.

FIG. 3B illustrates the server side 306 of the system 100 comprising the receiver-server device 106, in accordance with an embodiment of the present invention.

FIG. 3C illustrates a user interface accessible at the user device to control the receiver-server device, in accordance with an embodiment of the present invention.

FIG. 4A illustrates a process for determining a server address of the receiver-server device 106, in accordance with an embodiment of the present invention.

FIG. 4B represents a sequence diagram of the client side connecting to playing audio, in accordance with an embodiment of the invention.

### DETAILED DESCRIPTION OF THE EMBODIMENTS

In the following detailed description of embodiments of the invention, numerous specific details are set forth in order to provide a thorough understanding of the embodiment of invention. However, it will be obvious to a person skilled in the art that the embodiments of invention may be practiced with or without these specific details. In other instances well-known methods, procedures and components have not been described in detail so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a system and a method of utilizing a multi-tuner radio receiver-server device to provide access to a user anywhere, irrespective of his or her location, via the Internet to a selection of broadcast or other permissibly-used stations, on a live, near-live or time-shifted basis. In particular, the present invention provides a method of accessing received radio signal via any Internet-connected device without the impediments, such as being out of range or subject to interference, that often limit the value of broadcast signal tuned on a mobile receiver. Further, the present invention provides a system and a method for recording, storing and playing of media content broadcast over radio or through the Internet and not limited to traditional radio broadcasts, HD Radio broadcasts, satellite-radio broadcasts, internet-radio transmissions and the like.

Previously, with the conventional radio, there was not a provision to control and access broadcast data locally or remotely via a user's device such as a smartphone, a tablet or a computer on any of a number of preset stations that can be listened to in a live, near-live, or time-shifted mode.

Therefore, the present invention provides a system and a method for efficiently receiving and accessing radio signals, received by a receiver-server device that can be stored and listened to either in the live, near-live or time-shifted mode on any of a number of preset stations. Further, the present invention provides a way to access radio broadcasts received and stored on a personal receiver-server device from anywhere either remotely or locally. When accessed remotely, the receiver-server device may be in communication with a user's device such as a smartphone, a tablet, a computer and the like, via wired or wireless Internet communications. Receiving and accessing radio signals by a receiver-server device provides one-way wireless transmission of media content in the form of radio waves. These media content may be news, weather, interviews, entertainment, music, traffic reports and the like.

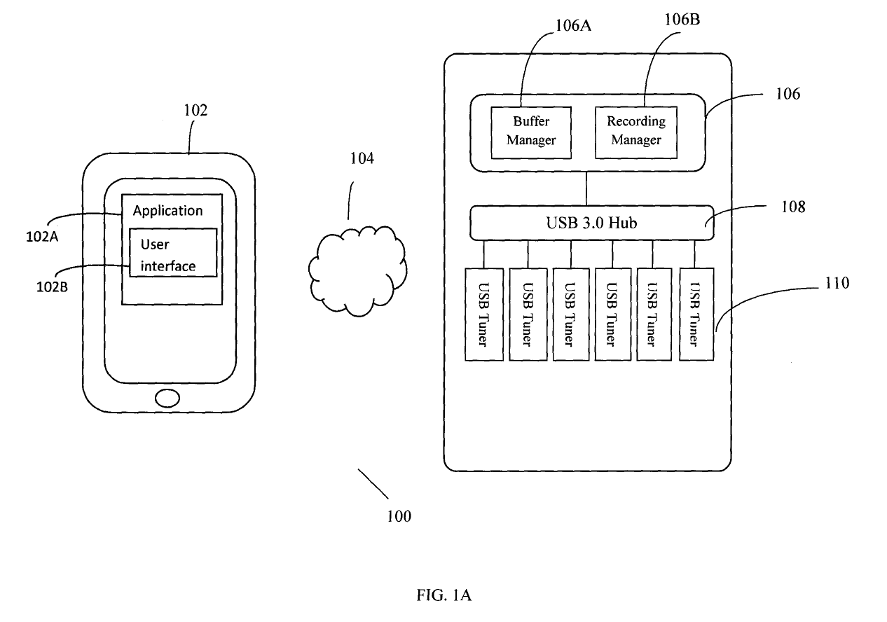

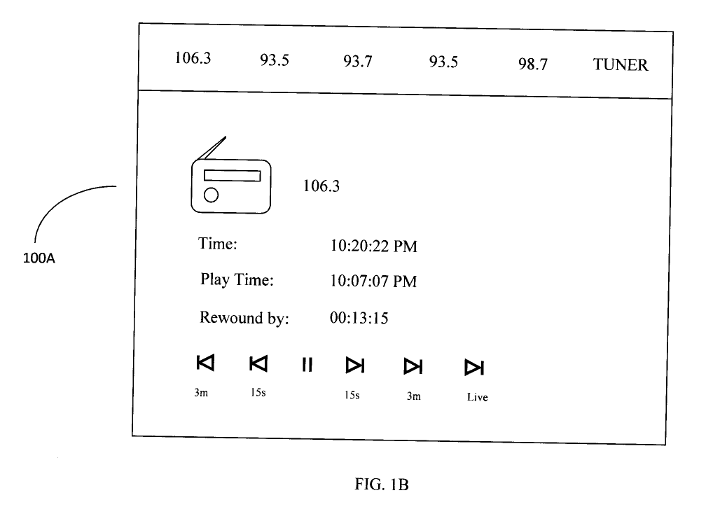

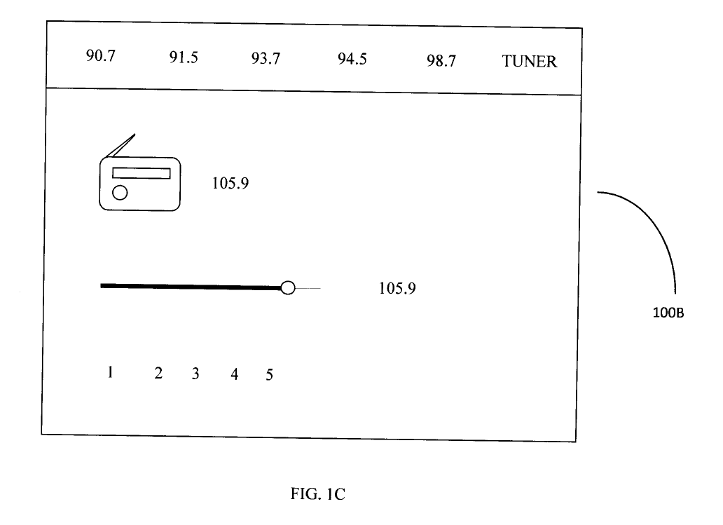

FIG. 1A illustrates a system for providing a multi-tuner radio receiver-server device and a user's device to locally or remotely access a preselected set of radio broadcast signals or Internet-streamed signals from anywhere, in accordance with an embodiment of the present invention. It comprises a receiver-server device 106 and a client or user's device 102 both in communication with each other over a communication network. The communication channel may be wired or wireless. The network may use wireless technologies to provide connectivity among various devices. The wireless technologies may include and not be limited to Wi-Fi, WiMAX, fixed wireless data, ZigBee, Home RF, IEEE 802.11, 4G or Long Term Evolution (LTE), Bluetooth, Infrared, spread-spectrum, Near Field Communication (NFC), Global Systems for Mobile communication (GSM), Digital-Advanced Mobile Phone Service (D-AMPS). In an embodiment, the network between the receiver-server device 106 and the user's device 102 is the Internet to provide global connectivity and access between the devices.

The receiver-server device 106 performs as a radio receiver that receives a plurality of radio stations' broadcast signals. In an embodiment, the radio signals are FM. In other embodiments, the radio signals may be AM, HD, DAB, satellite radio or any other over-the-air technology currently or hereinafter in use. In a further embodiment, the receiver-server device 106 communicates with the radio broadcast stations via the Internet. Further, the receiver-server device 106 may comprise at least one radio tuner subsystem 108 for connecting a plurality of radio tuner devices 110 that act as radio signals receivers. Preferably, the tuner subsystem 108 is a USB tuner Hub that connects with radio tuner devices 110, such as USB tuner sticks allowing them to be used as radio signal receivers.

In an embodiment of the present invention, the receiver-server device 106 is an Intel® DC3217IYE NUC small form factor computer with a USB 3.0 hub 108 and six RTL2838 FM radio USB tuners 110. Further, the receiver-server device 106 includes memory for storing radio broadcast information. Preferably, the receiver-server device 106 is configured with 128 GB of solid state storage and 8 GB of RAM. Preferably, the receiver-server device 106 is stationary and is located at a user desired location.

The receiver-server device 106 acts as a personal Internet server for the user that he or she can keep anywhere at a desired location. This creates a personal server for the user that allows access to the radio signals anytime and from anywhere, locally or remotely. The radio signals can thus be accessed remotely from anywhere in the world, irrespective of the user's location, when a user's device 102 is connected with the receiver-server device 106. On the other hand, the radio broadcast signals can be accessed locally, either when the receiver-server device 106 is itself acting as an output means for the radio broadcast signals enabling the user to listen to radio or to a connected user's device 102, within a short range of the receiver-server device's 106 location. Therefore, a system 100 that efficiently enables a user to access radio signals anywhere and anytime is provided.

System 100 also provides the user access to live, near-live and time-shifted playback of radio signals. In play mode, the user may be able to skip forward or backward or to pause a live stream of radio signal data as desired to monitor near-live broadcasts. This helps a user listen to any information he or she may have missed or wishes to listen to again. To enable the receiver-server device 106 to perform in near-live or a fully time-shifted mode, embodiments of the present invention provide an audio buffer manager 106A in the receiver-server device 106. The tuner subsystem 108 controls the tuner devices 110 and captures the audio to buffers. The audio buffer manager 106A handles configuration of the tuner subsystem 108 and the allocation of buffers, and copying any buffers to memory for fully time-shifted playback. Therefore, for the receiver-server device 106 to stream the radio signal data in near-live or time-shift mode, the receiver-server device 106 preferably utilizes the audio buffer manager 106A to allocate the data in buffers. In an embodiment, the buffers are circular buffers.

In an embodiment of the present invention, where the receiver-server device 106 comprises circular buffers, one for each tuner device 110, a write pointer is stored for each buffer, and a separate reader pointer is maintained for each attached client/user device 102. While in near-live mode, as the user skips forward or backward, the associated read pointer of the buffer is adjusted. The rate the radio signal data is sent to the user device 102 is controlled by the rate the data is captured from the USB stick 110. This allows the input rate from the tuner stick 110 to regulate the speed at which the data is sent to the user device 102 to avoid bursty data transmission or buffer overflows in the user device 102.

The receiver-server device 106 may also comprise a recording manager 106B. The recording manager 106B helps with time shifting of radio signals, so that a user is able to record a radio program to a storage medium to be listened to at a convenient time for the user. The recording preferably takes precedence over buffering presets for time shifting. The recording manager 106B handles the scheduling of recordings and the list of current recordings. Both the audio buffer manager 106A and the recording manager 106B communicate with the user over a web socket interface.

According to embodiments of the present invention, the user device 102 acts as a controller for the user to control the operation of the receiver-server device 106. The user device 102 comprises a user interface that further includes provisions for playing, pausing, rewinding, and fast forwarding the live feed of a radio program. The user interface also includes the capability to preset radio channels for a particular radio frequency. In an embodiment, the user can preset 5 channels for 5 different radio frequencies. The user interface also includes a tuner tab for selecting a radio frequency in order to preset a channel for it. Therefore, the user device 102 acts as a controller for the user to access the radio signals in live mode or to either rewind or skip-forward a live stream to listen to the radio broadcast in near-live mode. The user interface of the user device 102 is described in detail in conjunction with FIGS. 1B and 1C.

For accessing the radio signals locally, the receiver-server device 106 receives radio broadcasts from radio broadcast stations, either over-the-air or via the Internet, and outputs the radio signals via one or more speakers that may be connected to the receiver-server device 106. In this way, the receiver-server device 106 may act as both a radio receiver-server and an output device to listen to the radio signals. Additionally, a user device 102 can be connected to the receiver-server device 106 via short range communications technology, such as Bluetooth®. Thereby, a user may listen to a radio broadcast at the user device 102 while being present within the short range of the receiver-server device 106. Thus, the system 100 provides access to broadcast radio stations to the user from anywhere in the world via Internet on a live or near-live mode locally; and when remotely accessing, the user device 102 acts as an input/output controller and a remote device for that access from anywhere irrespective of the user's location. Hence, the system 100 provides a place-shift radio system, along with an ability to stream the radio signals in live and near-live mode.

The user device 102 may include but is not limited to a smart device such as a smartphone, a tablet, a laptop, a desktop and the like.

The user device 102 comprises a web based application 102A installed on it that enables it to act as an input/output controller. A user interface 102B provides an access to the web-based application program installed on the user device 102, such as a smartphone, a tablet, a computer and the like. In an embodiment, the user interface 102B comprises a tabbed user interface. Further, the web-based application program 102A is connected to the receiver-server device 106 to further control it via the Internet 104. The web-based application program 102A resides on a web server allowing for the user and the device 102 to be independent of the address of the receiver-server device 106. The web-based application 102A allows the user to schedule, record and store radio programs. Further, according to an embodiment, the user has a library of radio programs to listen to along with the streaming radio stations. With this library of content available, the application 102A allows for a recording to be downloaded to the user device 102 to allow for local playback, for the case that the user device 102 loses Internet access, for example, on a plane or in rural areas with spotty cellular coverage.

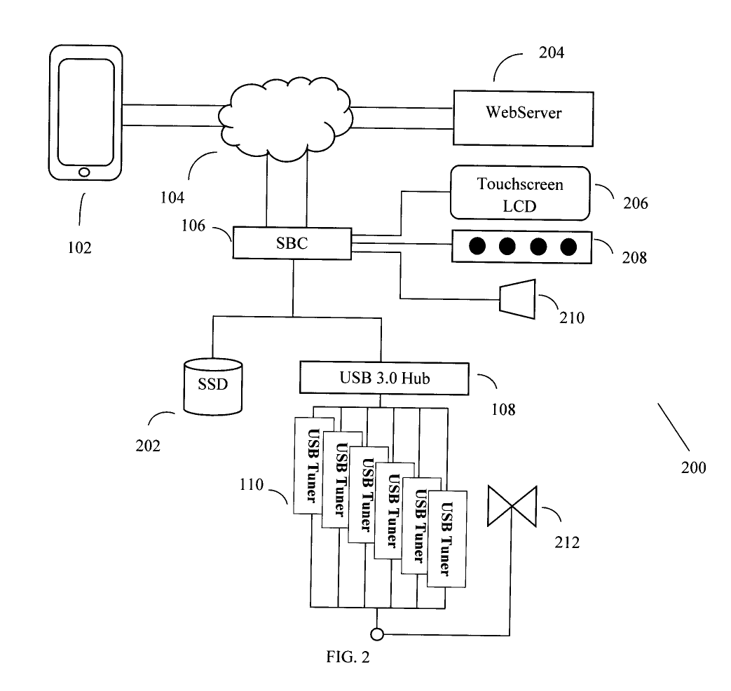

A user may log-in to the web-based application program 102A using the user device 102 to connect with the receiver-server device 106. The user may connect to the server to get the IP address of the receiver-server device 106 and then talk directly to the server for streaming of the audio. This is shown in FIG. 2. The web-based application 102A provides an interface 102B, as shown in conjunction with the FIGS. 1A and 1B. As described earlier, the user interface 102B provides control of the streaming of the radio programs on the user's device, when remotely accessing the radio data signals.

Therefore, embodiments of the present invention enable the user to be able to receive the radio signals irrespective of his or her location when the user device 102 is connected with the receiver-server device 106 via the Internet. Thereby, it creates a personal receiver-server for the user, enabling the user to access radio signals from a plurality of local or Internet broadcast stations from anywhere in the world via Internet access on a live, near-live or time-shifted basis.

FIG. 1B and FIG. 1C illustrate a user interface of a user device to control a receiver-server device for accessing radio broadcast or streamed signals, in accordance with an embodiment of the present invention. Embodiments of the present invention provide remote or local access to either live or near-live broadcasts or previously broadcast data on one or more preset stations. FIGS. 1B and 1C provide two different exemplary user screen displays 100A and 100B, respectively, for the user interface 102B. In an embodiment, the tabbed user interface 100A enables a user to switch tabs among 5 preset-station screens and one tuner screen as shown in FIG. 1B. The preset screen display enables a user to play audio on one or more preset stations in live mode and provide controls for time-shifting or operating in near-live mode. The preset screen displays the current time as well as the playback time of the stream received for the corresponding station. Six control buttons provide a skip-back-3-minutes button, a skip-back-15-seconds button, a play/pause button, a skip-forward-15-seconds button, a skip-forward-3-minutes button, and a go-to-live mode button. Further, the tuner screen, which is selected by clicking the “TUNER” tab in FIG. 1B, offers the ability to tune new stations and set presets. FIG. 1C depicts a user interface 100B showing a slider bar that allows for tuning to any new station and assigning it to a station preset by pressing a button marked 1, 2, 3, 4, or 5. In an embodiment, the tuner screen uses the 6th FM tuner to select a radio frequency for the 6^{th} tuner channel and to use that channel to assign presets 1 through 5.

FIG. 2 illustrates a system comprising a receiver-server device and a user device communicating with each other, for enabling a user access to radio signals, in accordance with an embodiment of the present invention. FIG. 2 provides a system 200 comprising the receiver-server device 106 and the user device 102 communicating via a wired or wireless network 104, preferably the Internet. Further, the receiver-server device 106 communicates with the webserver 204. A web-based application 102A resides on the webserver 204, which is further accessible from the user device 102 to control the operation of the receiver-server device 102 from a remote location. In an embodiment, the receiver-server device 106 is a single board computer (SBC) with a webserver 204 as shown in FIG. 2. The single board computer 106 is attached to a custom designed board with multiple tuner chipsets 110 that receive radio signals by an antenna 212. The receiver-server device 106 includes a solid state drive (SSD) 202 for storing buffered audio. Further, the receiver-server device 106 may comprise an input/output controller, such as a touchscreen liquid crystal display (LCD) 206, a control panel 208 or a speaker 210 for controlling the operation of the receiver-server device 106, such as for station selection, for scanning of available stations, and the like.

The receiver-server device 106 communicates with the webserver 204 via the network 104 to announce its internet protocol (IP) address and to allow a user to login to the web based application 102A using the user device 102. Once the user has been logged into the web based application 102A, then the user is allowed to connect to the receiver-server device 106 without having to know the IP address of the receiver-server device 106, which can be either in a local network or in a remote network. The user device 102 connects to the network 104 to get the IP address of the receiver-server device 106, then connects directly to the receiver-server device 106 for streaming of the audio signal. The connectivity between the user device 102 and the receiver-server device 106 is based on a handshake protocol that establishes a communication channel between the user device 102 and the receiver-server device 106 to precede data transfer.

Once communication between the user device 102 and the receiver-server device 106 is established after user login, the receiver-server device's information such as its IP address is stored on the webserver 204 in such a way that the user device 102 does not have to know where the receiver-server device 106 is connected to the Internet. When the tuner subsystem, such as USB Hub 108, receives signals via an antenna 212 that is connected to a plurality of tuner devices, such as USB tuners 110, the broadcast signals or buffered data corresponding to the preset tuned station are stored in the solid state drive 202 and may be listened to in a live mode, a near-live mode, or a time-shifted mode. The solid state drive 202 herein uses a plurality of circular buffers assigned to respective tuned stations as shown in FIG. 1B.

Referring now to FIG. 2, according to an embodiment, the receiver-server device 106 may also comprise an input/output control such as a touchscreen 206, a control panel 208 and a speaker 210. Such input means and the control panel provides a user interface with the receiver-server device 106 that further may help a user to control the receiver-server device 106 and select their desired choices of radio stations for assignment to preset channels, as shown in FIG. 1B. Also, in addition to this, the receiver-server device 106 may comprise an internal or an external speaker 210 for an output means of radio broadcast. It may be obvious to a person skilled in the art that the receiver-server device may comprise a variety of input and output means depending on its configuration. Therefore, the embodiment as shown in the FIG. 2 shows that the system 200 may also be able to perform without a remote controlling device, such as the user device 102. The system 200 in FIG. 2 allows for a local control and playback, removing the need for the handset or the user device 102.

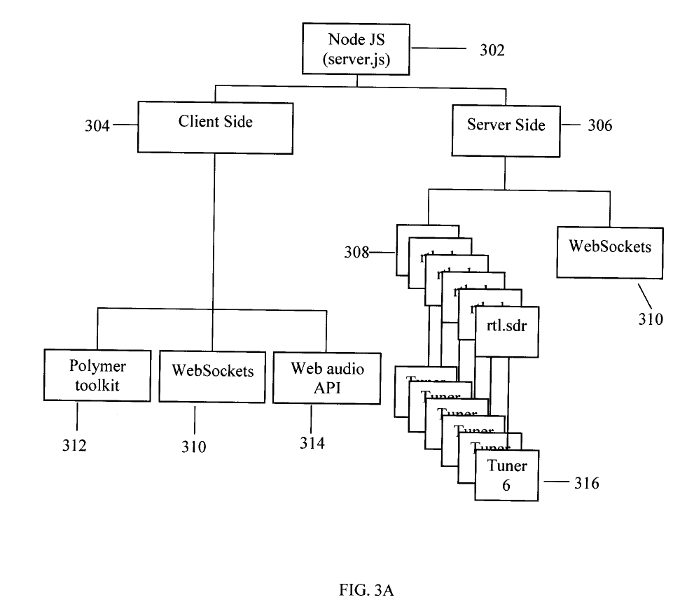

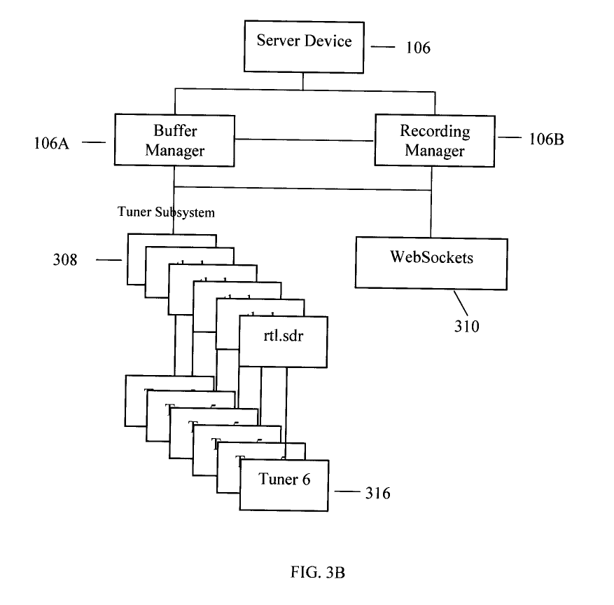

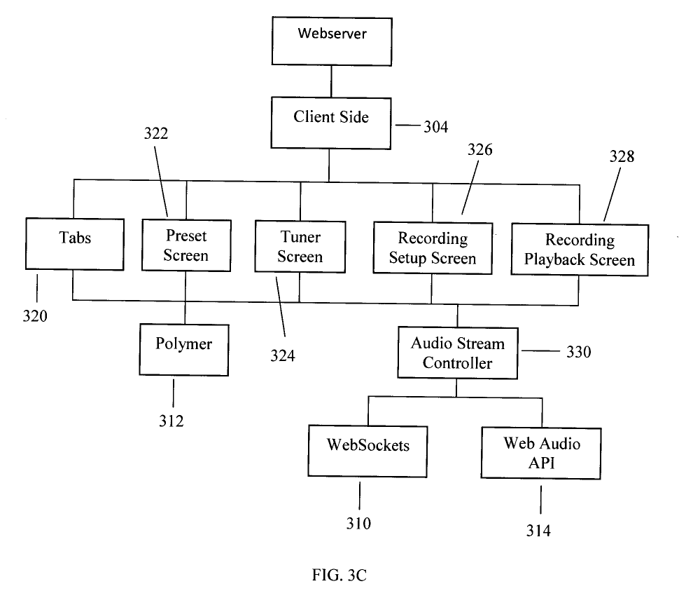

Referring to FIG. 3A, the software architecture of a system according to an embodiment of the present invention is shown having a client/user side 304 with a web application program and a server side 306. The client side 304 is served by the user device 102, whereas the server side 306 is served by the receiver-server device 106. Both sides are served by node.js 302, according to an embodiment. Node.js 302 is an open source and a cross platform runtime environment for server side and networking applications. An express webserver library serves the client side 304, wherein the client side 304 is a HTML5/javascript application. Further, the client side 304 interfaces with a user screen display built upon a Polymer toolkit 312, a communication protocol, websocket 310 and web audio application programming interface (API) 314. The client side 304 uses polymer toolkit 312 to display the user interface and serves HTML pages of the web-based application, using the express webserver library, to the user. The client side 304 communicates with the server side 306 via websocket 310 using a socket.io library, in an embodiment. The user device 102 at the client side 304 receives the broadcast data or audio stream or media content from the receiver-server device 106 at the server side 306 using the web audio application programming interface (API) 314. In an embodiment, the web audio API 314 is a javascript API for rendering audio in a platform agnostic manner, allowing audio playback on an Android®, an iOS®, a personal computer (PC), a Mac® system or the like. The web application program 102A simulates a standard radio interface with 5 preset buttons, a skip-15-seconds-forward button, a skip-15-seconds-backward button, a skip-3-minutes-forward button, a skip-3-minutes-backward button, a pause/play button, a go-to-live button, and a tuner interface. The current time, playback time, and station information are also displayed as shown in FIG. 1B.

The server side 306 is preferably a node.js/javascript application. According to an embodiment referred to in FIG. 3A, the server side 306 interfaces to the USB tuners 110 using rtl.sdr 308, wherein rtl.sdr 308 is a software defined radio that allows the configuration of the radio station frequency, the sampling frequency and audio format. In an embodiment of the present invention, a solution to record six audio streams of 32 KHz mono 16 bit audio is provided. The first five USB tuners 110 are assigned to the preset stations, the sixth tuner is provided to enable the user to tune the stations accordingly as shown in FIG. 1B. In addition, there is a control data channel that allows for switching of the USB tuners 110, setting of the frequencies, skipping forward and backward, and setting of the presets.

FIG. 3B illustrates the server side 306 of the system 100 comprising the receiver-server device 106, in accordance with an embodiment of the present invention. Referring to FIG. 3B, the receiver-server device 106 comprises an audio buffer manager 106A and a recording manager 106B. In an embodiment, the audio buffer manager 106A buffers the broadcast data or audio stream or media content for up to 90 minutes and streams the broadcast data or audio stream or media content to the client side 304 via websockets 310 using the socket.io library. The audio buffer manager 106A uses a plurality of buffers, such as circular buffers, to provide temporary storage to the broadcast data or audio stream or media content selected by the user so that the user can playback a live audio stream. Moreover, the core of playback is to transfer a pulse code modulated (PCM) data that the client side 304 prefixes with a pre-defined waveform audio file format (WAV) file header for easy decode. The decoded data is added to the circular buffers present in the audio buffer manager 106A to permit continuous playback without gaps or interruptions.

In an embodiment of the present invention, there are six circular buffers provided for each of the USB tuners 110. A write pointer is stored for each circular buffer and a separate reader pointer is maintained for each of the attached user devices 102. As a user skips forward or backward, the associated read pointer is adjusted. The rate at which the data is sent to the user device 102 is controlled by the rate at which the data is captured through input. This allows the input rate from a tuner stick to regulate the speed at which the data is sent to the user device 102 to avoid buffer overflows at the user device 102.

In other words, a tuner subsystem 108 is provided to control the USB tuners 110 and capture the broadcast data or audio stream or media content to the circular buffers. The audio buffer manager 106A handles configuration of the tuner subsystem 108 and the allocation of buffers, and copying any buffers to disk for recording. In addition, a recording manager 106B is provided for managing scheduling of recordings and a list of current recordings. Both the audio buffer manager 106A and the recording manager 106B communicate with the user device 102 over a two way protocol, such as websocket interface 310, http 2.0, CoAp and the like, so that the user can listen to live or near-live or previously broadcast data or audio stream or media content. In an embodiment of the present invention, the user can have a library of radio programs to listen to along with the streaming stations. With this library of media content available, the web application program allows for a recording to be downloaded to the corresponding user device 102, such as a smartphone or tablet or computer or the like, to further allow for local playback in cases where the smartphone loses cellular service or Wi-Fi service, for example on a plane or in rural areas with spotty coverage.

The client web application 102A, available as the user interface for the receiver-server device 106 resides on the webserver 204 allowing the user to be independent of the address of the receiver-server device 106. Once, the user has been logged into the receiver-server device 106 then the user is allowed to connect to the receiver-server device 106 without worrying about whether the receiver-server device 106 is in the local network or a remote network.

FIG. 3C illustrates a user interface of a web-based application accessible at the user device 102 to control the receiver-server device 106, in accordance with an embodiment of the present invention. The user interface 102B provides access from the user device 102 to the web-based application 102A that further connects and controls the operation of the receiver-server device 106. According to an embodiment, the user interface 102B of the web-based application 102A comprises tabs 320, preset screens 322, a tuner screen 324, a recording setup screen 326, a recording playback screen 328, a polymer toolkit 312, an audio stream controller 330 interfaced with a websocket 310 and a web audio API 314 as shown in FIG. 3C. Tabs 320 are provided at the user interface to enable the user to select any of the preset radio stations or the tuner screen as shown earlier in FIG. 1B and FIG. 1C. In an embodiment, the tabs 320 switch among the 5 presets screens 322 and the tuner screen 324. Further, a recording setup screen 326 is provided to schedule recordings and the recording playback screen 328 is provided to handle the selection of recordings to play back, the playback control, and the optional download of recordings for local playback.

The user device 102 uses a polymer toolkit 312 to display the user interface and serves the HTML pages to the user using Express webserver library. The user device 102 communicates with the webserver 204 using the websocket protocol 310 and thus receives the broadcast data or audio stream or media content from the webserver 204 using the Web Audio API 314. The web audio API 314 is preferably a javascript API for rendering audio in a platform-agnostic manner, allowing audio playback on an Android®, an iOS®, a PC, a Mac® system and the like. The streaming is controlled by the audio stream controller 330.

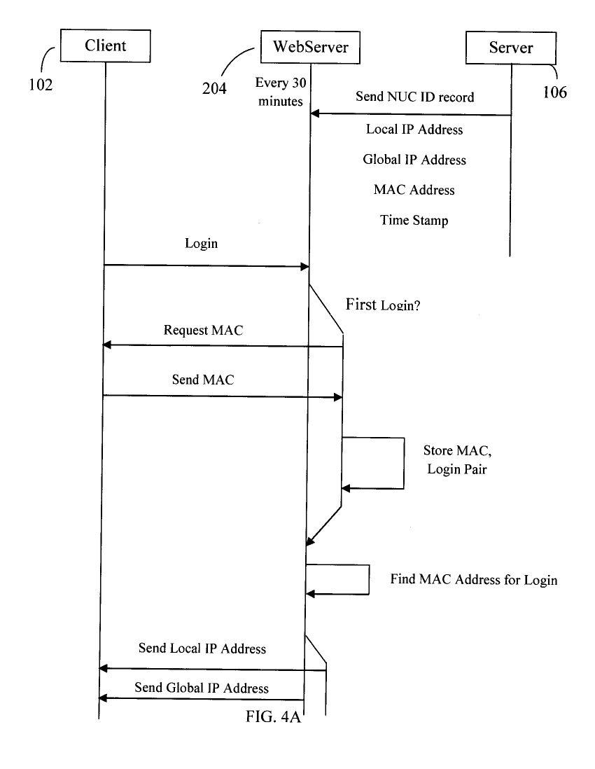

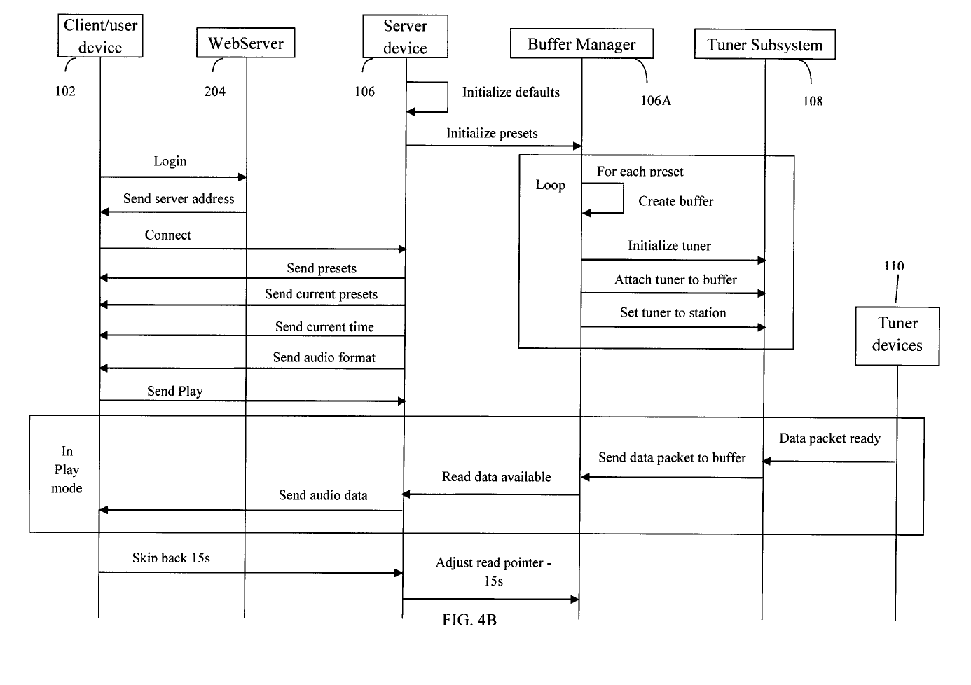

FIG. 4A illustrates a process for determining a server address of the receiver-server device 106, in accordance with an embodiment of the present invention. Initially, when the radio receiver-server device 106 is turned on, it sends its server identification (ID) record to a web application program 102A running on a webserver 204 at a time interval, for example of 30 minutes. The ID record may comprise a local IP Address, a global IP Address, a media access control (MAC) Address and time stamp of the radio receiver-server device 106. Simultaneously, at the client side 304, a user logs into the web application 102A installed on the user device 102 and communicating with the webserver 204. If this is the user's first login into the web application 102A running on the webserver 204, then the web application 102A requests the MAC address from the user's device 102. Thereafter, the client/user device sends the MAC address to the webserver 204.

Once the connection between the user device 102 and the webserver 204 has been established after the user login, user device 102 information, such as a MAC address and login pair, are stored on the webserver 204. The next time the user wants to login, the web application program 102A running on the webserver 204 allows the client to auto-find the MAC address for login and sends either the local IP address or global IP address of the receiver-server device 106 to the user device 102 depending upon whether both the devices are sharing the same network or not. When both devices are on the same network, then the local IP address is provided to the user operating the user device 102; otherwise the global IP address of the receiver-server device 106 is provided. In this way, the connection between the receiver-server device 106 and the user device 102 is established, wherein the user device 102 is a smartphone or a tablet or a computer and the like and runs the web application on the webserver 204.

Referring now to FIG. 4B, a sequence diagram of the client side connecting to playing audio is shown, in accordance with an embodiment of the invention. FIG. 4B shows communication among a client/user device 102, a webserver 204, a receiver-server device 106, an audio buffer manager 106A, a tuner subsystem 108 and tuner devices 110. When the receiver-device 106 is turned on, presets are initiated and sent to the audio buffer manager 106A. Additionally, the receiver-server device 106 sends request to the audio buffer manager 106A to initialize presets. For each initiated preset, a buffer is created by the audio buffer manager 106A. Thereafter, the audio buffer manager 106A sends commands to the tuner subsystem 108, so that the tuner 110 is initialized, is attached to the respective buffer, and set or tuned to a radio station. When the user logs in to the Web application from a user device, the webserver 204 sends the IP address of the corresponding receiver-server device 106 to the user device 102. The webserver 204 has the local IP address, global IP address, MAC address and a time stamp of the last update of the receiver-server. At this point, the user device 102 knows the location of the receiver-server device 106. Additionally, the receiver-server device 106 sends presets, current preset, current time and audio format to the user device 102. Then, the user sends play commands to the receiver-server device 106 via the web based application program running at the user device 102 and thus audio plays in the tuner or preset modes.

In another embodiment, there are six tuner inputs in which one tuner is adjustable interactively and five tuners are assigned to user presets. This embodiment allows configuration of the preset stations using the interactive tuner.

While in play mode, when data packets are ready from the tuned station, the data packets are sent to the audio buffer manager 106A. The buffer stores the data packets corresponding to the tuned station. The receiver-server device 106 further reads the available data sent from the buffer in the form of data packets. At the next step, the available data is thus sent to the user device 102 in the form of audio data. The audio data is the signal delivered from the receiver-server device 106. This mode provides options to skip the audio data in forward and backward manner; such as a skip forward 15 seconds, a skip forward 3 minutes, a skip backward 15 seconds, or a skip backward 3 minutes. Also, pause/play and go-to-live buttons are provided in the play mode. The user interface of the user device 102 displays both clock time and playback time of current station in the play mode as represented in the FIG. 1B.

In an embodiment, circular buffers are provided for storing the data packets sent from the tuned stations. A write pointer is stored for each circular buffer and a separate reader pointer is maintained for each of the attached client/users of the user device 102. As the client/user skips forward or backward, the associated read pointer is adjusted. The rate at which the data is sent to the client/user device 102 is controlled by the rate at which the data is captured from the tuner. This allows the data rate from a tuner stick to regulate the speed at which the data is sent to the client/user device 102 to avoid buffer overflows at the client/user.

Therefore, the present invention provides a multi-tuner radio equipped with antenna capacity suitable for acquiring signal from multiple stations via the Internet or via multiple over-the-air bands and formats, including amplitude-modulation (AM), frequency-modulation (FM), high-definition (HD), satellite, and any over-the-air format now or hereinafter in use, that can be played into two modes, a tuner mode and a play mode. The tuner mode provides the audio output from a tuned station to be available only in live mode. In this mode, station selection is controllable by direct digital input on a soft keypad, scanning of available stations and a software-operated tuner-control bar. Any of these methods can be used to select a station. There can be a variety of input methods known in the art that may be easily configured with the system. While in the tuner mode, the user can assign any selected station from one of the bands to one of multiple preset channels. Each channel is assigned a memory buffer, preferably suitable to store 60 to 120 minutes of live broadcast or media content. However, the memory buffer is not limited to 60 to 120 minutes.

In addition, in play mode, one of the preset channels is selected. In this mode, the user can listen in live or near-live mode, and can rewind or fast-forward the audio stream in a variety of increments, pause the stream or return the stream to live mode.

Advantageously, the present invention provides a method of accessing received radio signal via any internet-connected device so that the users can enjoy music, talk, news or sports in a vehicle or otherwise while traveling without any discontinuities such as being out of range or subject to interference and without other limitations affecting the value or quality of the broadcast signal tuned on the mobile receiver.

Also, the present invention enables a user to listen to radio broadcast or streams from any location in the world irrespective of his or her location, using a smart device that is connected via the Internet with a receiver-server device that in turn receives radio signals from a plurality of radio originators. Further, the present invention also enables a user to listen to the radio broadcast in live or near-live mode. This allows the user to skip backward or forward or pause or play a live stream of radio data on his or her device, whenever he or she wishes to. This way, user may be able to listen to any radio broadcast that he or she just missed on a station assigned to one of the preset memory channels. Also, the present invention provides a means to record the radio broadcast programs, schedule recordings for future programs, and download the recordings to his or her device to be able to listen them to a convenient time.

In particular, the present invention provides a method of accessing lawfully received radio signal via an Internet-connected device without the impediments, such as being out of range or subject to interference, that often limit the value of broadcast signal tuned on a mobile receiver.

We claim:

1) A system for enabling a user to listen to a radio signal comprising:
a receiver-server device, capable of receiving radio signals from a plurality of radio broadcast stations;
at least one user device, communicating with the receiver-server device through a communication network, configured to control and playback the radio signals; and
an audio buffer manager configured in the receiver-server device to allow live and near-live access to the radio audio data to said at least one user device;
wherein the system allows the user to control and listen to the radio signals at said at least one user device from anywhere irrespective of the user's location.

2) The system as claimed in claim 1, wherein said at least one user device communicates with the receiver-server device through a wired and/or wireless communication network.

3) The system as claimed in claim 2, wherein the wireless communication network may be cellular, Internet, or any short or long range communication.

4) The system as claimed in claim 1, wherein a web-based application for remotely controlling the operation of the receiver-server device is configured on said at least one user device.

5) The system as claimed in claim 4, wherein a user interface of the web-based application comprises a plurality of preset channels, a tuner channel, and a means to skip backward and forward, to pause, and to play a live or near-live stream of radio broadcast signal at said user device.

6) The system as claimed in claim 1, wherein the receiver-server device is configured with a recording manager for recording the broadcast of the radio signals, scheduling recording, and maintaining a list of current recordings, enabling the download of recordings for local playback and related functions.

7) The system as claimed in claim 1, wherein the receiver-server device further comprises a tuner subsystem connected with a plurality of tuner devices for receiving radio signals from radio broadcast stations and capturing audio for the audio buffer manager.

8) The system as claimed in claim 1, wherein the audio buffer manager comprises circular memory buffers to store live broadcast of radio signals.

9) The system as claimed in claim 1, wherein said user device has one or more built-in internal speakers or connects to one or more external speakers for local control and audio output of radio broadcast signals.

10) The system as claimed in claim 1, wherein said at least one user device is a smartphone, a tablet, a computer, a laptop, or another such mobile or Internet-connected device.

11) The system as claimed in claim 1, wherein the receiver-server device receives media content in the form of radio signals, where the media content includes news, weather reports, interviews, entertainment, music, traffic reports, and audio content.

12) The system as claimed in claim 1, wherein the receiver-server device acts as a personal server for the user to receive radio broadcast signals accessible from any location by the user on said at least one user device.

13) The system as claimed in claim 1, wherein the receiver-server device is stationary and is located at a user desired location.

14) A multi-tuner, radio receiver-server device enabling a user to listen to radio signals comprising:
a means to receive radio signals from a plurality of radio broadcast stations;
a means to connect to at least one user device, via the Internet, providing access to the radio signal from anywhere via said at least one user device;
an audio buffer manager configured to allow live and near-live streaming of the radio signals; and
a web-based application program configured with a user interface, installed in the receiver-server device providing input/output control, to the user, of each radio station signals, and to access live and near-live streaming of the radio signals.

15) The device as claimed in claim 14, wherein the radio receiver-server device acts as a personal receiver-server device for the user to listen to a plurality of radio broadcasts and further comprises a tuner subsystem with a plurality of tuner channels to receive radio broadcast signals from radio stations.

16) The device as claimed in claim 14, wherein the radio receiver-server device receives radio signals via over-the-air broadcasts or Internet streams.

17) The device as claimed in claim 14, wherein the radio receiver-server device further comprises a speaker for output of the radio signals.

18) The device as claimed in claim 14, wherein the user interface is a control panel that may be a touchscreen, a mouse, a keyboard and the like.

19) The device as claimed in claim 14 having a tuner mode.

20) The device as claimed in claim 14 having a play mode.

21) A user-location-independent system enabling access of radio signals by a user comprising:
a multituner radio receiver-server device which receives radio signals from a plurality of radio stations;
an audio buffer manager configured in the receiver-server device to provide live and near-live playback of the radio signals on at least one user device;
the at least one user device, which communicates with the radio receiver-server device via the Internet, to control and monitor radio signals; and
a web based application, configured on said at least one user device, comprising a user interface to control the live and near-live streaming of the radio signals on said at least one user device;
wherein the radio receiver-server device is configured to perform as a personal server for the user.

22) The system as claimed in claim 20, wherein the receiver-server device receives radio signals from multiple stations via the Internet or via multiple over-the-air bands and formats, including AM, FM, HD, satellite, and any over-the-air format, that can be played into two modes, a tuner mode and a play mode.

23) The system as claimed in claim 20, wherein the near live mode allows skipping a live streaming of the radio signals forward and backward.

24) The system as claimed in claim 20, wherein the radio signals may be accessed using either a local IP address or global IP address of the multituner radio receiver-server device.

25) The system as claimed in claim 20, wherein the web-based application is also installed in the radio receiver-server device for local operation control; and a touchscreen, control panel and speaker are provided for local control and playback without the need for the user device.

26) The system as claimed in claim 20, wherein a recording manager is configured within the radio receiver-server device to allow the user to record, schedule recordings, and store radio programs.

27) The system as claimed in claim 20, wherein the audio buffer manager and the recording manager communicate with said at least one user device over a two way protocol.
